(19) United States
(12) Patent Application Publication
(10) Pub. No.: US 2010/0309652 A1
(43) Pub. Date: Dec. 9, 2010

(54) LED LIGHT BAR WITH A REPLACEABLE POWER SOURCE

(75) Inventors: Feng-Jui Shen, Changhua City (TW); Chien-Chin Wang, Shengang Township (TW); Shih-Hsu Yang, Changhua City (TW)

Correspondence Address: Wang Law Firm, Inc., 4989 Peachtree Parkway,, Suite 200, Norcross, GA, 30092, US

(73) Assignees: IOVISION PHOTOELECTRIC CO., LTD., CHANGHUA CITY (TW); GENIUS ELECTRONIC OPTICAL CO., LTD., DAYA Township (TW)

(21) Appl. No.: 12/545,802

(22) Filed: Aug. 21, 2009

(30) Foreign Application Priority Data
Jun. 6, 2009 (TW) 098210072

(51) Int. Cl. F21L 4/00

(52) U.S. Cl. 362/157

(57) ABSTRACT

An LED light bar with a replaceable power source. A base is inserted with an LED lamp. A lampshade covers the lamp. Both ends of the base have a connector. One connector is connected with a power supply. A connecting base is provided between the power supply and the end portion of the base. This forms the disclosed LED light bar with a replaceable power supply.

### BACKGROUND OF THE INVENTION

1. Field of Invention

The invention relates to a light bar and, in particular, to an LED light bar with a replaceable power source structure.

2. Related Art

FIG. 7 shows a conventional light-emitting diode (LED) light bar. An LED lamp 91 is inserted on a base 90. A lampshade 92 covers the lamp 91. Both ends of the base 90 have connector 93, respectively, for electrically connecting with the base 90. The end portion of the lamp 91 is disposed with a power supply 94.

When the above-mentioned conventional light bar starts, the power supply 94 at the end portion of the lamp 91 supplies the electrical power. Although the LED has the features of power-saving and long lifetime, the risk for the electronic elements in the power supply 94 to fail is difficult to estimate. Its lifetime cannot match with that of the lamp 91. Therefore, when the power supply 94 fails, one has to replace the entire set of light bar. This is a waste.

As shown in FIG. 8, two LED light bars A and B are electrically connected to an electronic ballast 95. The electronic ballast 95 shown in the circuit is an electronic preheat electronic ballast made in Japan.

Suppose the two fluorescent lamps start and take the LED light bar A as an example. The input terminals 96 of its power source have the voltage in the waveforms shown in FIG. 9. The red and blue curves are complementary to each other, providing a stable wave. The two fluorescent lamps emit light stably.

However, when the two fluorescent lamps are replaced by lamps of other specifications, the new ones cannot be lit up. If current energy-saving LED light bars are used, the voltages curves are shown in FIG. 10. One is higher than the other, rendering an unstable waveform. In this case, one LED light bar is brighter than the other. This low compatibility is one of the problems in the prior art.

It is thus an objective of the invention to solve the above-mentioned problem with the LED light bars.

### SUMMARY OF THE INVENTION

An objective of the invention is to provide an LED light bar with a replaceable power source. This achieves the goal of making full use of the LED light bar and saving costs.

Another objective of the invention is to make the LED light bar with capacitors applicable to all kinds of preheat electronic ballast. It has a stable voltage input.

To achieve the above objectives, the invention includes: a LED lamp installed on a base with a heat-dissipating stricture; a lampshade covering the lamp from the base, and a connector electrically connected to the lamp base on each of the two ends of the base.

The invention is further characterized in that the connector on one end of the base is provided with a power supply. The base has connector base for the power supply on that end. The power supply and the connector base can be fixed units that can be separated and assembled. They have quick-connect terminals for the power supply to electrically connect to the lamp. The connectors on both ends of the base have a first terminal and a second terminal, respectively. The first terminal of each of the connectors electrically connects to the corresponding electrode on the power supply. The two second terminals are connected in series with a capacitor for stabilizing the voltage.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention;

FIG. 2 is a three-dimensional exploded view of the invention;

FIG. 3 is a schematic cross-sectional view of the disclosed structure;

FIG. 4 is a schematic view when the fixed units of the invention are separated;

FIG. 5 is a schematic view of the invention with capacitors;

FIG. 6 is a schematic view of the disclosed light bar with capacitors in use;

FIG. 7 is a three-dimensional exploded view of a conventional light bar;

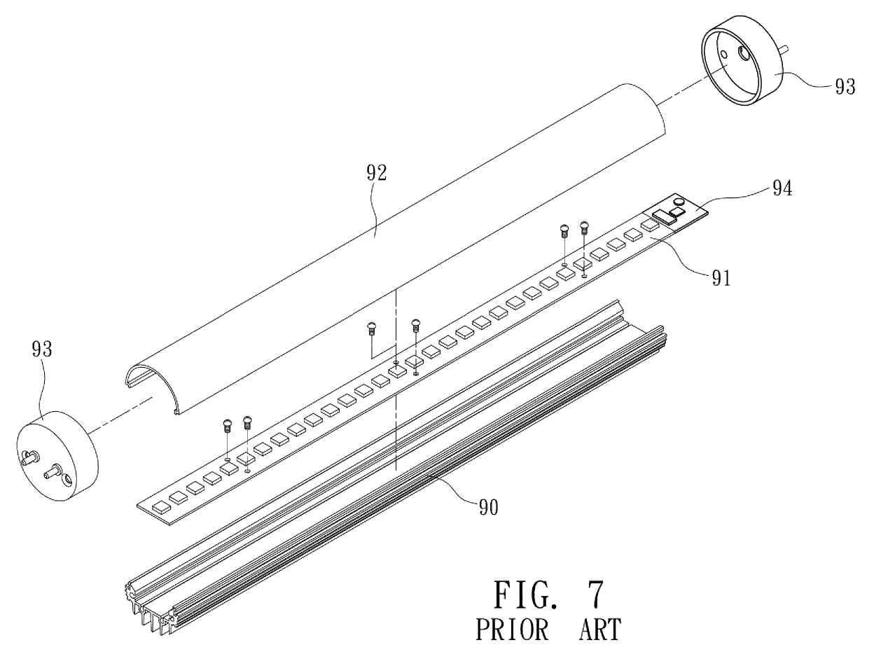

FIG. 8 shows a conventional light bar in use;

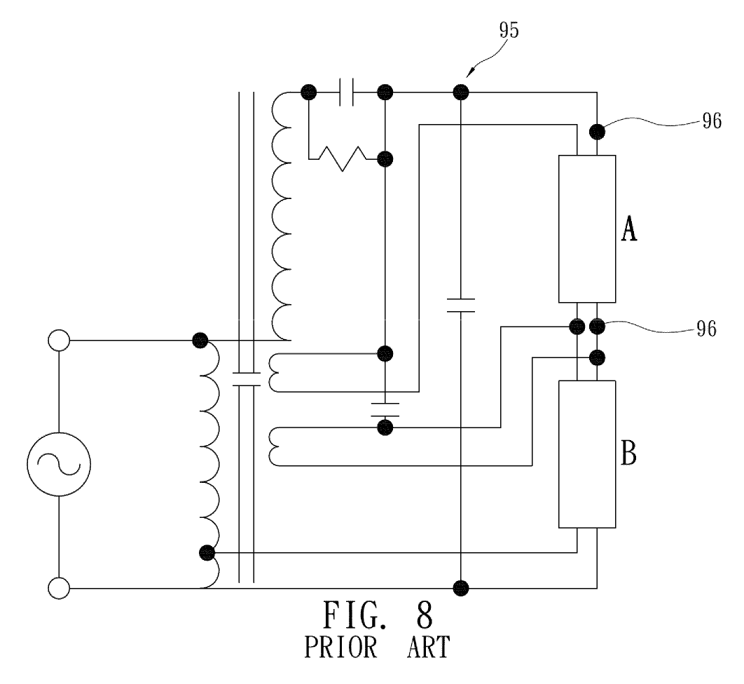

FIG. 9 shows the waveforms on the power input terminals in FIG. 8;

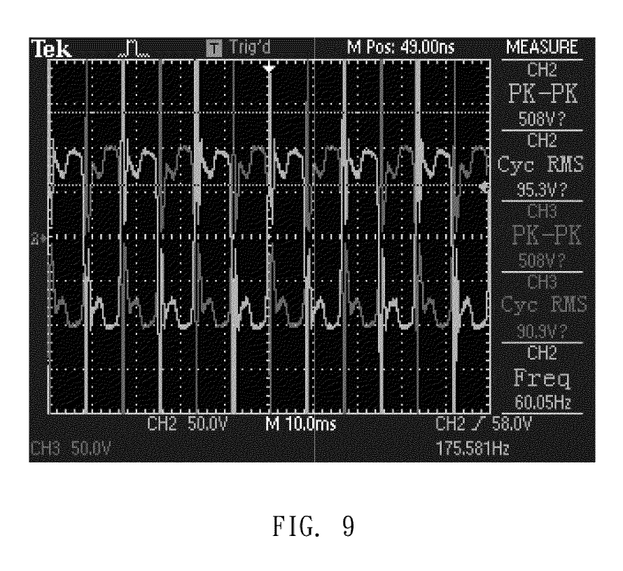

FIG. 10 shows the waveforms on the power input terminals in FIG. 8 when an energy-saving LED light bar is installed; and

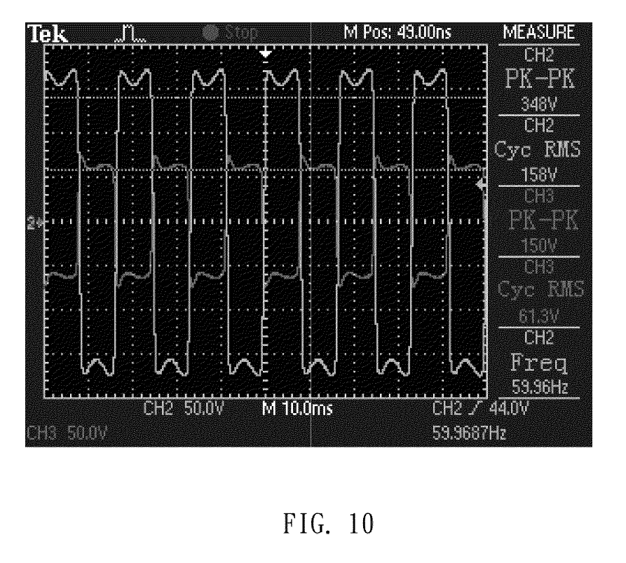

FIG. 11 shows the input waveforms of the invention with capacitors.

### DETAILED DESCRIPTION OF THE INVENTION

The present invention will be apparent from the following detailed description, which proceeds with reference to the accompanying drawings, wherein the same references relate to the same elements.

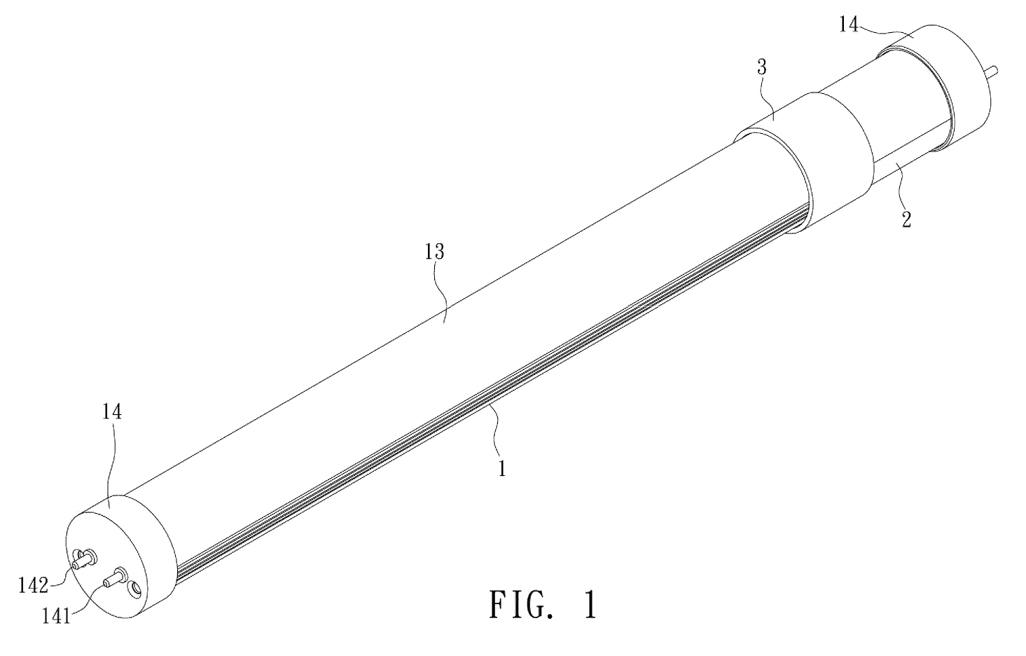

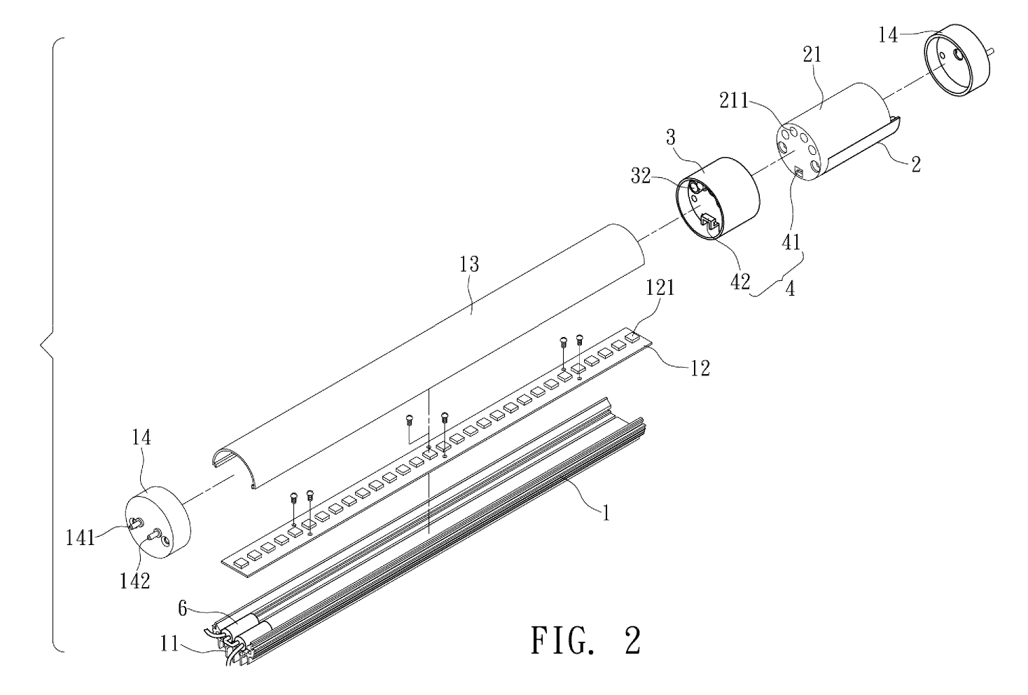

Please refer to FIGS. 1 and 2, which show an embodiment structure of the invention. It is only for the purpose of illustration. The invention is not limited to this particular structure.

This embodiment provides an LED light bar with a replaceable power source. It includes a base 1 and a power supply.

The base 1 has a heat-dissipating structure 11 and is disposed with a lamp 12. The lamp 12 uses an LED 121 as its light-emitting element. A lampshade 13 covers the lamp 12 from the base 1. Each of the two ends of the base 1 has a connector 14 electrically connected to the lamp base.

The power supply 2 is disposed at the connector 14 on one end of the base 1. The base 1 also has a connector base 3 on that end for the power supply 2 to mount and connect. Moreover, a fixing unit 4 is disposed between the power supply 2 and the connector base 3. The fixing unit 4 enables the two parts to be quickly separated or assembled.

The fixing unit 4 in this embodiment is also shown in FIG. 2 to 4. One end of the power supply 2 has a blocking part 41. The connector base 3 has a positioning part 42. When they are assembled together, the positioning part 42 and the blocking part 41 block and position each other.

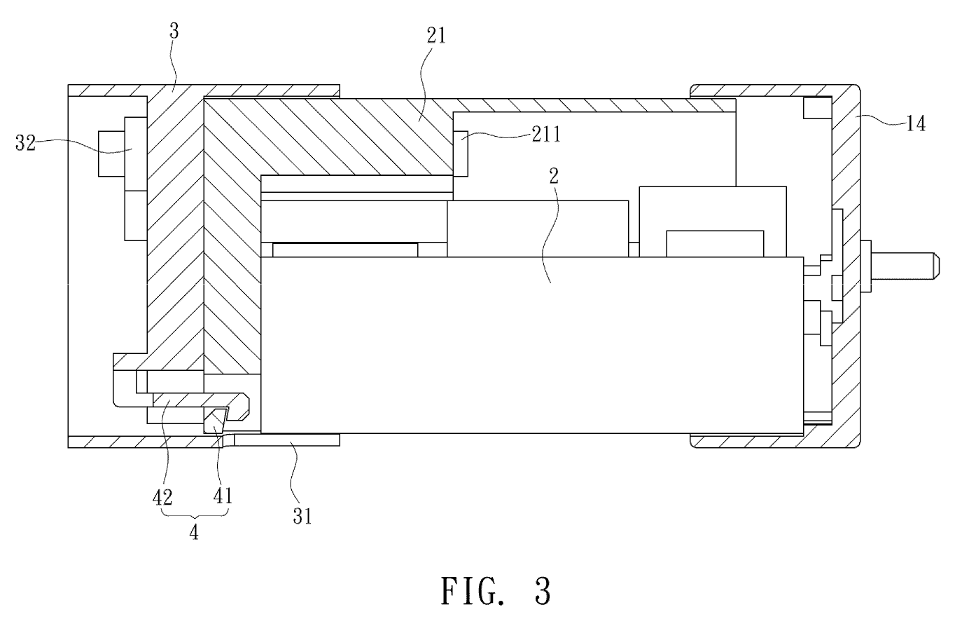

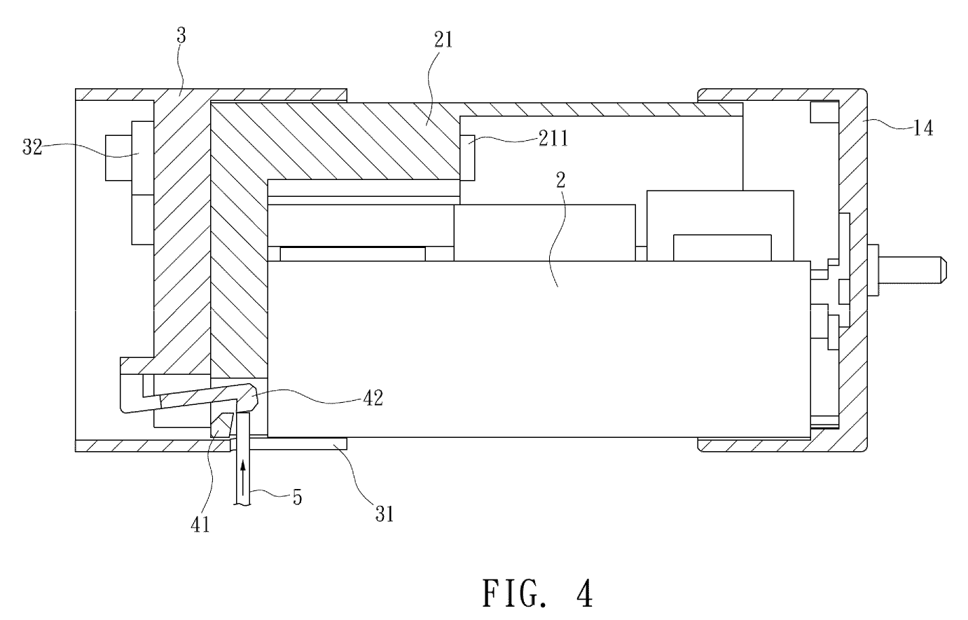

As shown in FIGS. 3 and 4, the connector base 3 has a long hole 31 corresponding to the positioning part 42. To separate the power supply 2 from the connector base 3, one can use the tool 5 in the drawing to push the positioning part 42 away, so that the positioning part 42 is no longer blocked by the blocking part 41.

Besides, the power supply 2 has a quick-connect terminal 211, and the connector base 3 also has a quick-connect terminal 32. After the power supply and the connector base are assembled together, the connection of the quick-connect terminal 211 and the quick-connect terminal 32 enables the power supply 2 to electrically connect and provide power to the lamp 12.

In this embodiment, the power supply 2 is covered with a cover 21. The quick-connect terminal 211 of the power supply 2 is provided on the cover 21 and electrically connects to the quick-connect terminal 32 of the connector base 3. One of the quick-connect terminals 32 of the cover 21 and the connector base 3 is male, and the other is female to be connected together. In this embodiment, the quick-connect terminal 211 of the cover 21 is male, and the quick-connect terminal 32 on the connector base 3 is female.

The connectors 14 on both ends of the base 1 have respectively a first terminal 141 and a second terminal 142. The first terminal 141 of each connector electrically connects to an AC power source. Capacitors 6 for stabilizing voltage are connected between the two second terminals 142.

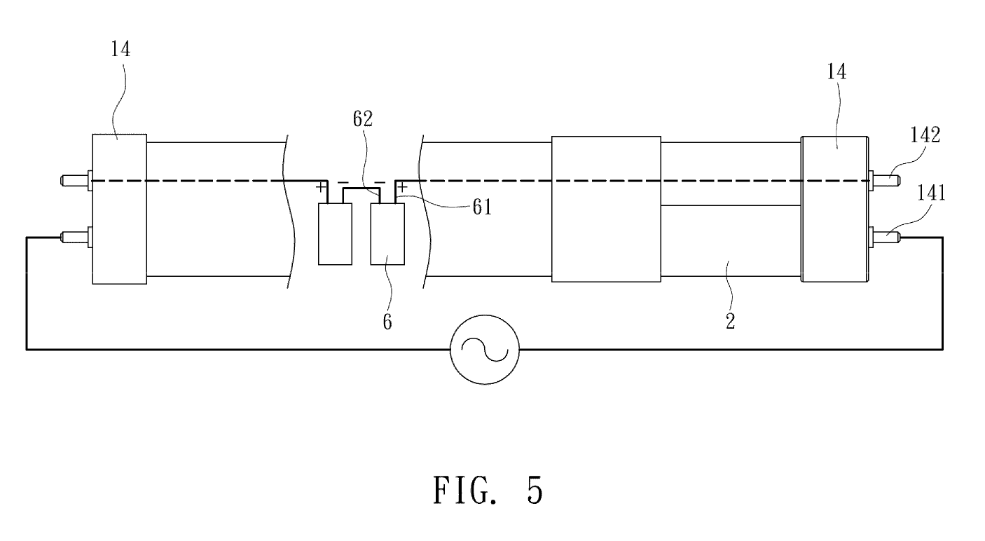

As shown in FIG. 5, the capacitors 6 are DC electrolytic capacitors, and there are two of them. Each of the capacitors 6 has a positive connecting point 61 and a negative connecting point 62. The negative connecting points 62 of the two capacitors 6 are connected together. The two positive connecting points 61 are connected in parallel to the second terminals 142 of the connectors 14. Besides, the capacitors can be AC non-polar capacitors. In this case, the two connecting points of the non-polar capacitor are connected in parallel between the second terminals 142 of the connectors. The capacitance of the above-mentioned DC electrolytic capacitor or AC non-polar capacitor is between 1 μF and 10 μF.

According to the above structure, when the power supply 2 of the disclosed LED light bar fails, one only needs to take off the power supply 2 and replace it with a new part. In comparison with the LED light bar in the prior art, the invention is more cost-effective.

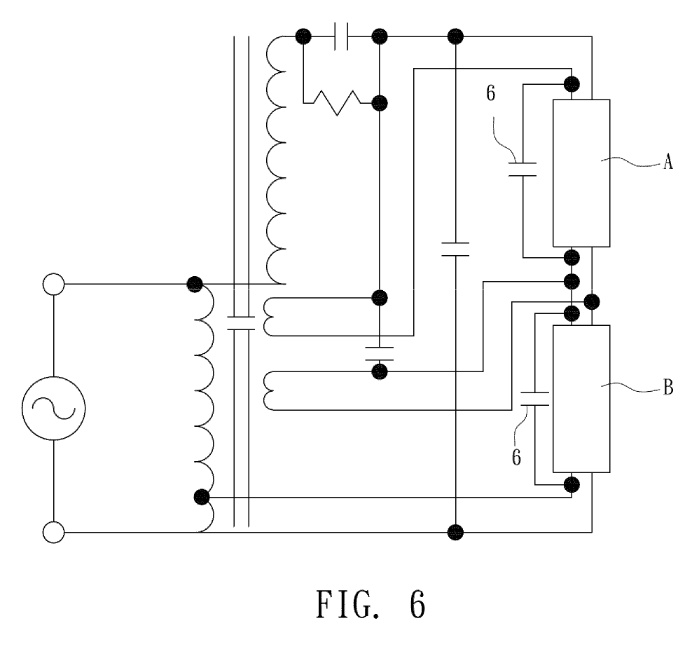

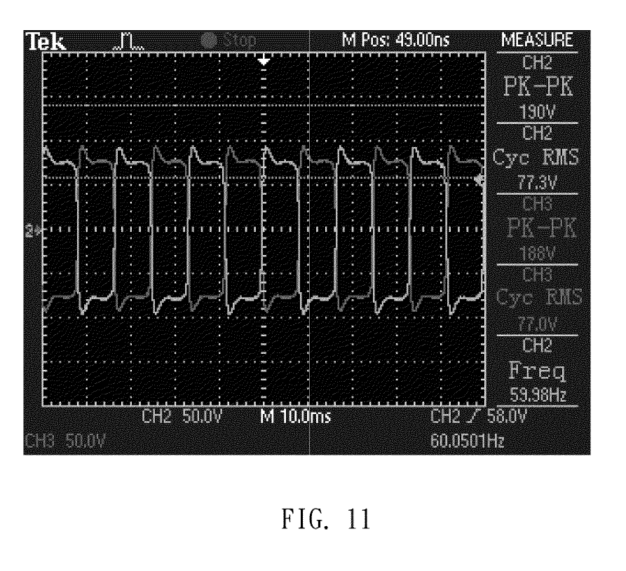

Moreover, the disclosed LED light bar has capacitors 6. As shown in FIG. 6, the disclosed two LED light bars A and B are accompanied by the RAPID preheat electronic ballast made in Japan. The waveforms of the voltage on the input terminals of A and B are shown in FIG. 11. The waveforms thus obtained are as stable as the lamp set (including fluorescent lamp) using the RAPID preheat electronic ballast made in Japan. Therefore, the disclosed LED light bar with capacitors 6 can be used with all kinds of electronic ballasts. This can achieve the effect of stabilizing voltage.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A light-emitting diode (LED) light bar with a replaceable power source, comprising:
a lamp using LED elements disposed on a base with a heat-dissipating structure;
a lampshade covering the lamp from the base; and
a connector on each end of the base electrically connected to the lamp base;
wherein the connector on one end of the base has a power supply and a connector base for the power supply to mount; the power supply and the connector base have fixing elements for them to separate or assemble together; and the power supply and the connector base have quick-connect terminals for the power supply to electrically connect to the provide electrical power to the lamp.

2. The LED light bar with a replaceable power source as in claim 1, wherein each of the connectors on both ends of the base has a first terminal and a second terminal, the first terminals are electrically connected to an AC power source, and the two second terminals are connected in parallel with a capacitor for stabilizing voltage.

3. The LED light bar with a replaceable power source as in claim 1, wherein the power supply is covered with a cover, and the quick-connect terminal of the power supply is provided on the cover and electrically connects to the quick-connect terminal on the connector base.

4. The LED light bar with a replaceable power source as in claim 3, wherein one of the quick-connect terminals of the cover and the connector base is male and the other is female correspondingly.

5. The LED light bar with a replaceable power source as in claim 1, wherein the fixing element has a blocking part on one end of the power supply, and the connector base has a positioning part that block and position the blocking part when they are connected.

6. The LED light bar with a replaceable power source as in claim 2, wherein the capacitors are AC and non-polar, and the two connecting points of the capacitor are electrically connected to the second terminals of the connectors.

7. The LED light bar with a replaceable power source as in claim 2, wherein the capacitors are DC connectors with a positive connecting point and a negative connecting point, the number of capacitors is two, and the negative connecting points of the two capacitors are connected in series and the two positive connecting points are electrically connected to the first terminals of the connectors, respectively.
